(19) United States
(12) Patent Application Publication
(10) Pub. No.: US 2020/0351143 A1
(43) Pub. Date: Nov. 5, 2020

(54) DATA PROCESSING METHOD AND DEVICE, CONTROLLER, AND MOVABLE DEVICE

(71) Applicant: SZ DJI TECHNOLOGY CO., LTD., Shenzhen (CN)

(72) Inventors: Wenjun WANG, Shenzhen (CN); Guangyuan LIN, Shenzhen (CN); Zhendong WANG, Shenzhen (CN)

(21) Appl. No.: 16/931,225

(22) Filed: Jul. 16, 2020

Related U.S. Application Data
(63) Continuation of application No. PCT/CN2018/073452, filed on Jan. 19, 2018.

(51) Int. Cl. H04L 29/06; H04L 12/24; H04L 29/08

(52) U.S. Cl. CPC H04L 29/06; H04L 41/0206; H04L 67/12; H04L 41/5096

(57) ABSTRACT

A data processing method includes determining a target amount according to a first amount indicating an amount of obtained data that a sensor has currently obtained and a second amount calculated according to the first amount and a preset calculation rule, reading sensor data from the sensor according to the target amount, and transmitting the read sensor data.

### CROSS-REFERENCE TO RELATED APPLICATION

This application is a continuation of International Application No. PCT/CN2018/073452, filed Jan. 19, 2018, the entire content of which is incorporated herein by reference.

### TECHNICAL FIELD

The present disclosure relates to the field of computer technology, and in particular, to a data processing method and a device, a controller, and a movable device.

### BACKGROUND

With the development of sensor technology, the application of sensors is becoming more and more extensive. Especially in the field of intelligent control, the dependence on sensors is becoming stronger and stronger. The real-time capability of sensor data directly determines the real-time effect of intelligent control. Especially in some systems requiring high precision and high real-time capability, the delay of sensor data will seriously affect the stability of the system. For example, in a wind resistance system of a flight control system, a robot-arm is more sensitive to the delay of sensor data during a high-speed movement. If sensor data lags, it will directly cause the control of the wind resistance system to overshoot, or even oscillate in severe cases. As a result, the control of the entire flight control system is unstable. Therefore, how to improve the real-time performance of reading sensor data is a critical problem to be solved.

### SUMMARY

In accordance with the disclosure, there is provided a data processing method including determining a target amount according to a first amount indicating an amount of obtained data that a sensor has currently obtained and a second amount calculated according to the first amount and a preset calculation rule, reading sensor data from the sensor according to the target amount, and transmitting the read sensor data.

Also in accordance with the disclosure, there is provided a movable device including a movable device body and a data processing device provided at the movable device body. The data processing device includes a controller configured to determine a target amount according to a first amount indicating an amount of obtained data that a sensor has currently obtained and a second amount calculated according to the first amount and a preset calculation rule, read sensor data from the sensor according to the target amount, and transmit the read sensor data.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts.

FIG. 1 is a schematic flowchart of a data processing method according to an embodiment of the present disclosure.

FIG. 2 is a schematic timing diagram of sampling and reading of sensor data according to an embodiment of the present disclosure.

FIG. 3 is a schematic structural diagram of a data processing device according to an embodiment of the present disclosure.

FIG. 4 is a schematic structural diagram of another data processing device according to an embodiment of the present disclosure.

FIG. 5 is a schematic structural diagram of a movable device according to an embodiment of the present disclosure.

### DETAILED DESCRIPTION OF THE EMBODIMENTS

The technical solutions in the embodiments of the present disclosure will be described in more detail with reference to the accompanying drawings in the embodiments of the present disclosure.

The present disclosure provides a data processing method and a device, a controller, and a movable device, which are applied to mobile terminals, mobile platforms, and smart devices equipped with sensors. The sensors include pressure sensors, position sensors, speed sensors, gravity sensors, gyroscopes, and etc. By adopting the data processing method and device, the controller, and the movable device provided by the embodiments of the present disclosure, the sensor data can be read in advance, thereby reducing the delay of reading sensor data and effectively improving the real-time performance of reading sensor data. A detailed description is as follows.

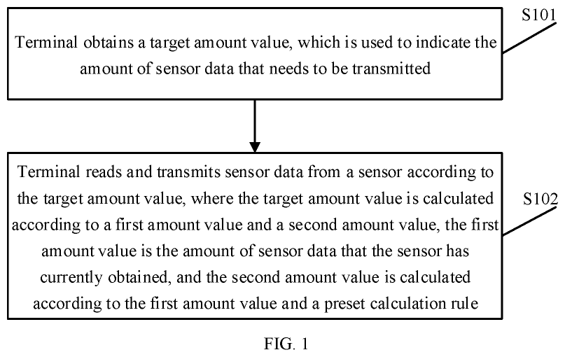

FIG. 1 is a schematic flowchart of a data processing method according to an embodiment of the present disclosure. At S101, a terminal obtains a target amount value, and the target amount value is used to indicate the amount of sensor data that needs to be transmitted. In this disclosure, an amount of sensor data is also referred to as a “sensor data amount” or simply “data amount.”

In some embodiments, the terminal first reads a first amount value (first amount), and the first amount value is the amount of sensor data currently obtained by a sensor preset at the terminal. The sensor data currently obtained by the sensor is also referred to as “obtained sensor data” or “obtained data.” The terminal can read the first amount value from a sensor configured at the terminal and can also read the first amount value from a register configured to store sensor data at the terminal. The terminal then calculates a second amount value (second amount) according to the first amount value and a preset calculation rule. Calculating the second amount value according to the first amount value and the preset calculation rule refers to that with the second amount value, the time for the sensor to obtain sensor data of the amount corresponding to the second amount value is not greater than a target time value (target time). The target time value includes at least the sum of the time for the terminal to read sensor data of the amount corresponding to the first amount value (also referred to as “the first amount of sensor data”), and the time to read sensor data of the amount corresponding to the second amount value (also referred to as “the second amount of sensor data”). The terminal finally calculates the target amount value according to the first amount value and the second amount value.

In some embodiments, the target amount value is the sum of the first amount value and the second amount value. The time for the terminal to read sensor data of the amount corresponding to the first amount value includes the product of the first amount value and the time of the terminal reading a single unit of data (a unit amount of data). The time for the terminal to read sensor data of the amount corresponding to the second amount value includes the product of the second amount value and the time of the terminal reading a single unit of data. The time of the terminal reading a single unit of data (also referred to as a “unit-reading time”), that is, the time of the terminal reading a single unit of sensor data, includes the product of the size of the single unit of sensor data (bytes) and the time of the terminal reading one byte of sensor data.

In some embodiments, the time for the terminal reading sensor data of the amount corresponding to the first amount value includes the product of the first amount value and the time of the terminal reading a single unit of data, plus the time for reading a single unit of data. Because it may happen that the terminal reading sensor data and the sensor sampling to obtain sensor data start at the same time, and the terminal reading the first unit of sensor data cannot be executed until the sensor sampling the first unit of sensor data is finished, the terminal reading sensor data is later than the sensor sampling to obtain sensor data. Therefore, the time for reading a single unit of data is added to the time for the terminal to read sensor data of the amount corresponding to the first amount value to ensure there is data to read when the terminal reads sensor data and ensure that all sensor data of the amount corresponding to the first amount value can be read.

Further, in some embodiments, the time for the terminal reading sensor data of the amount corresponding to the second amount value includes the product of the second amount value and the time of the terminal reading a single unit of data minus the time of reading a single unit of data. Because it may happen that the terminal's clock for reading sensor data and the sensor's clock for sampling sensor data are not synchronized, in order to ensure that the terminal does not read incomplete sensor data when reading sensor data, the time for reading a single unit of data is subtracted from the time for the terminal to read sensor data of the amount corresponding to the second amount value. Therefore, the last sensor data is discarded when the terminal reads sensor data to ensure that the sensor data read by the terminal is always complete sensor data.

In some embodiments, the target time value further includes a response time when the terminal reads sensor data, and the response time includes at least a calculation time for calculating the second amount value according to the first amount value and the preset calculation rule. The response time also includes the execution time of the terminal software, such as the startup time of the terminal software.

In some embodiments, the response time includes the time duration from when the terminal starts to read sensor data to when the first byte of sensor data is read, and the time to assign a value to the terminal register, or the time to write sensor data into the register, and etc.

At S102, the terminal reads and transmits sensor data from the sensor according to the target amount value.

In some embodiments, the sensor is connected to the sensor data receiver through a bus. The terminal first sends a data reading instruction with the target amount value to the sensor, and the data reading instruction is used to instruct the sensor to transmit sensor data of the amount corresponding to the target amount value to the sensor data receiver. The sensor data receiver may be a controller of the terminal or another device of the terminal. The sensor may also be connected to the sensor data receiver in other ways, which is not limited in the embodiments of the present disclosure.

In some embodiments, the register storing sensor data is connected to the sensor data receiver through the bus. The terminal first sends a data reading instruction with the target amount value to the register, and the data reading instruction is used to instruct the register to transmit sensor data of the amount corresponding to the target amount value to the sensor data receiver. The register may be a part of the sensor, or may exist independently in the terminal, or the register may be connected to the sensor data receiver in another way, which is not limited in the embodiments of the present disclosure.

In some embodiments, after obtaining the target amount value, the terminal sets the amount of bus-transmitted sensor data to the amount corresponding to the target amount value before reading and transmitting sensor data from the sensor according to the target amount value. When the amount of sensor data transmitted via the bus is less than the amount corresponding to the target amount value within the preset time period, an error is reported. When the amount of sensor data that needs to be transmitted via the bus greater than the amount corresponding to the target amount value within the preset time period, the bus is controlled to no longer transmit sensor data. Further, the terminal sends a data reading instruction with the target amount value to the bus, and the data reading instruction is used to instruct the bus to obtain sensor data of the amount corresponding to the target amount value from the sensor and transmit the obtained sensor data to the sensor data receiver.

In some embodiments, before obtaining the target amount value, the terminal first obtains the bus type of the bus connecting the sensor and the sensor data receiver and determines the reading duration of one byte of sensor data according to the bus type of the bus. That is the time that one byte of sensor data takes to be transmitted from the sensor to the sensor data receiver. The bus can be a serial peripheral interface (SPI). The SPI is a high-speed, full-duplex, synchronous communication bus. The bus can also be an integrated circuit bus (IIC). The bus may also be another type of bus, which is not limited in the embodiments of the present disclosure.

Further, the terminal obtains the type of the sensor, and determines the sampling rate of the sensor according to the type of the sensor and the size of the single unit of sensor data, that is, the number of bytes of the single unit of sensor data. According to the reading duration of one byte of sensor data and the size of a single unit of sensor data, the reading duration of the terminal reading a single unit of data can be determined, and according to the sampling rate of the sensor, the time of the sensor obtaining sensor data of the amount corresponding to the second amount value can be determined.

In some embodiments, after the terminal determines the sampling rate of the sensor according to the type of sensor, according to the sampling rate of the sensor and the capacity of the register that stores the sensor data, the rate at which the terminal reads the sensor data is set to ensure the amount of sensor data stored in the register does not exceed the capacity of the register.

In some embodiments, an interrupt triggering method is adopted by the sensor, and a preset amount value can be set according to a preset interrupt mechanism. When the sensor obtains sensor data with a preset amount, the terminal is triggered to start reading sensor data according to the target amount value. The preset amount is the amount corresponding to the first amount value, the target amount value is determined in advance according to the preset amount value and the second amount value, and the second amount value is determined in advance according to the preset interrupt mechanism, the preset amount value, the sampling rate of the sensor, and the preset calculation rules. In the above method, the first amount value, the second amount value, and the target amount value are all determined values, and there is no need for the terminal to calculate the second amount value and the target amount value based on the real-time sampling rate of the sensor, the reading rate of the sensor data, and the first amount value when it reads the sensor data. Therefore, the response time when the terminal reads the sensor data can be reduced, and the real-time performance of reading sensor data can be further improved to a certain extent.

To more clearly explain the technical solutions in the embodiments of the present disclosure, the following example is used for description. It is assumed that the sensor is a gyroscope sensor, and the sensor and the sensor data receiver are connected through an SPI transmission bus. The time for SPI transmission bus to transmit 1 byte of sensor data is T(byte). The gyro sensor sampling rate is SR(gyro), and the time duration from when the terminal starts sensor data transmission to when the first byte of sensor data starts transmitting is T(delay). The first amount value is the amount of sensor data currently obtained by the gyroscope sensor and is N0, and the size of a single unit of sensor data is Size, then the time duration of the terminal to read a single unit of data is T(byte)*Size.

Further, it is assumed that from the beginning of reading sensor data by the terminal to the end of reading sensor data, the terminal reads N1 more units of sensor data and N1 is the amount of sensor data read in advance when the terminal reads the sensor data, that is, the second amount value. Then, it needs to be satisfied that the time for the gyroscope sensor to generate N1 units of sensor data is less than or equal to the time for the terminal to read (N1+N0) units of sensor data, that is, the time to generate N1 units of sensor data<=the time to read (N1+N0) units of sensor data. According to the above parameters, the following formulas can be obtained:

time to generate N1 units of sensor data=N1*1/SR(gyro); (1)

time to read (N1+N0) units of sensor data=T(delay)+T(byte)*(N0*Size+1+(N1−1)*Size); (2)

where T(byte)*N0*Size is the reading time of the sensor data corresponding to the first amount value, T(byte)*(N1−1)*Size is the reading time of the sensor data corresponding to the second amount value. “+1” in Formula (2) is to ensure that the time of one byte of data is left to the register for assigning value, and N1−1 in formula (2) is to ensure that the terminal reads complete sensor data. Then, according to Formula (1) and Formula (2), the following formula can be derived:

N1*1/SR(gyro)<=T(delay)+T(byte)*(N0*Size+1+(N1−1)*Size). (3)

The following formulas can be obtained by transforming Formula (3):

K1*(N1)<=K2*(N0*Size)+B; (4)

K1=/SR(gyro)−T(byte)*Size; (5)

K2=T(byte); (6)

B=T(delay)−T(byte)*(Size−1); (7)

N1<=(K2*(N0*Size)+B)/K1. (8)

Therefore, a maximum value of N1 can be calculated according to Formula (3) or Formulas (5) to (8). This N1 is the amount of sensor data that can be read in advance when the terminal reads sensor data. The target amount value may be the sum of N1 and N0, and the target amount value may also be a value greater than N0, but less than the sum of N1 and N0.

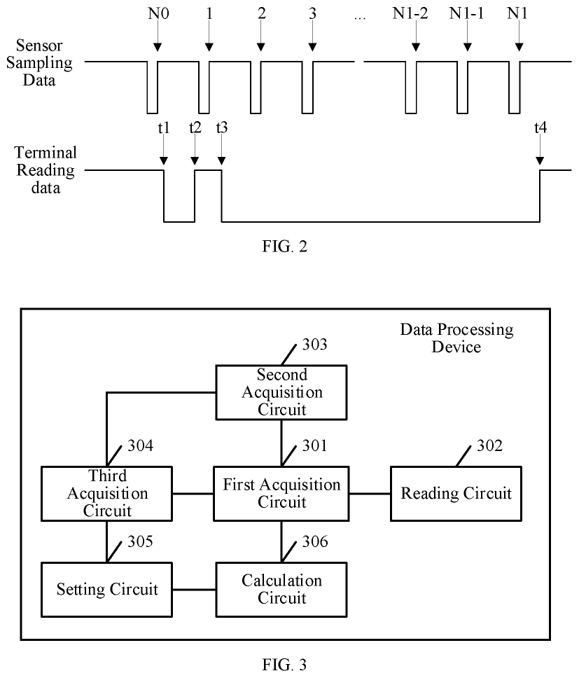

FIG. 2 is a schematic timing diagram of sampling and reading of sensor data according to an embodiment of the present disclosure. As shown in FIG. 2, N0 is the amount of sensor data currently obtained by the sensor, t1 is the time when the terminal starts reading the value of N0, t2 is the time when the terminal finishes reading the value of N0, t3 is the time when the terminal starts reading the first byte of sensor data, and t4 is the time when the terminal finishes reading the (N0+N1) units of sensor data. In order to meet the condition that the time when the sensor generates N1 units of sensor data is less than or equal to the time when the terminal reads (N1+N0) units of sensor data, N1 should satisfy N1*1/SR(gyro)<=t4−t2.

In some embodiments, the delay in reading or transmitting sensor data can be dynamically calculated to obtain the amount of sensor data that can be read in advance, and the calculated amount of sensor data that can be read in advance is added to the current known amount of sensor data when reading sensor data. Then the sensor data is read and transmitted once. That is, when the sensor data is transmitted via the bus, not only sensor data of the amount corresponding to the first amount value, but also sensor data of the amount corresponding to the target amount value set for the bus is transmitted. Therefore, it can be ensured that the moment when the reading of the sensor data is completed is the moment when the last sensor data of the sensor is generated in the above process. By adopting the above method, the delay of reading sensor data can be effectively reduced, and the real-time performance and stability of reading sensor data can be improved, as a result, overshoot and oscillation caused by the delay of reading sensor data can be avoided.

In some embodiments, the terminal first obtains the target amount value, which is used to indicate the amount of sensor data that needs to be transmitted, and then reads and transmits sensor data from the sensor according to the target amount value. The target amount value is calculated according to the first amount value and the second amount value, the first amount value is the amount of sensor data that the sensor has currently obtained, and the second amount value is calculated according to the first amount value and the preset calculation rule. By adopting the above method, the sensor data can be read in advance, which can reduce the delay of reading the sensor data, and ensure that after each data reading is completed, the sampled sensor data basically has no residue. As a result, the real-time performance of reading sensor data is effectively improved.

FIG. 3 is a schematic structural diagram of a data processing device according to an embodiment of the present disclosure. As shown in FIG. 3, the data processing device includes a first acquisition circuit 301, a reading circuit 302, a second acquisition circuit 303, a third acquisition circuit 304, a setting circuit 305, and a calculation circuit 306.

The first acquisition circuit 301 is configured to obtain a target amount value, which is used to indicate the amount of sensor data that needs to be transmitted. The reading circuit 302 is configured to read and transmit sensor data from the sensor according to the target amount value.

The target amount value is calculated according to a first amount value and a second amount value, the first amount value is the amount of sensor data that the sensor has currently obtained, and the second amount value is calculated according to the first amount value and a preset calculation rule.

In some embodiments, calculating the second amount value according to the first amount value and the preset calculation rule refers to that with the second amount value, the time for the sensor to obtain sensor data of the amount corresponding to the second amount value is not greater than a target time value.

The target time value includes at least the sum of the time to read sensor data of the amount corresponding to the first amount value, and the time to read sensor data of the amount corresponding to the second amount value.

In some embodiments, the target time value further includes a response time when the terminal reads sensor data, and the response time includes at least a calculation time for calculating the second amount value according to the first amount value and the preset calculation rule.

In some embodiments, the time to read sensor data of the amount corresponding to the first amount value includes the product of the first amount value and the time to read a single unit of data, and plus the time to read a single unit of data.

In some embodiments, the time to read sensor data of the amount corresponding to the second amount value includes the product of the second amount value and the time to read a single unit of data minus the time to read a single unit of data.

In some embodiments, the first acquisition circuit 301 is configured to read the first amount value, calculate the second amount value according to the first amount value and the preset calculation rule, and calculate the target amount value according to the first amount value and the second amount value.

In some embodiments, the target amount value is a sum of the first amount value and the second amount value.

In some embodiments, the second acquisition circuit 303 is configured to obtain a bus type of a bus and determine the reading duration for reading single unit of data according to the bus type.

In some embodiments, a third acquisition circuit 304 is configured to obtain the type of the sensor.

The third acquisition circuit 304 is also configured to determine the sampling rate of the sensor according to the type of the sensor.

The setting circuit 305 is configured to set the reading rate of sensor data according to the sampling rate and the capacity of the register, so as to ensure that the sensor data stored in the register does not exceed the capacity of the register.

In some embodiments, the first amount value being the amount of sensor data that the sensor has currently obtained refers to that according to a preset interrupt mechanism, when the sensor acquires sensor data with a preset amount, the data processing device is triggered to start reading sensor data according to the target amount value. The preset amount is the amount corresponding to the first amount value.

In some embodiments, the calculation circuit 306 is configured to calculate the second amount value according to the first amount value, the sampling rate, and the preset calculation rule.

The functions of each functional module of the data processing device according to the embodiments of the present disclosure may be implemented according to the method in the embodiments mentioned above. For the specific implementation process, reference may be made to the related description of the above embodiments, and details are not repeated here.

In some embodiments, the first acquisition circuit 301 first obtains the target amount value, which is used to indicate the amount of sensor data that needs to be transmitted, and then triggers the reading circuit 302 to read and transmit the sensor data from the sensor according to the target amount value. The target amount value is calculated based on the first amount value and the second amount value, the first amount value is the amount of sensor data that the sensor has currently obtained, and the second amount value is calculated according to the first amount value and the preset calculation rules. By adopting the above method, the sensor data can be read in advance, which can reduce the delay of reading the sensor data, and ensure that after each data reading is completed, the sampled sensor data basically has no residue. As a result, the real-time performance of reading sensor data is effectively improved.

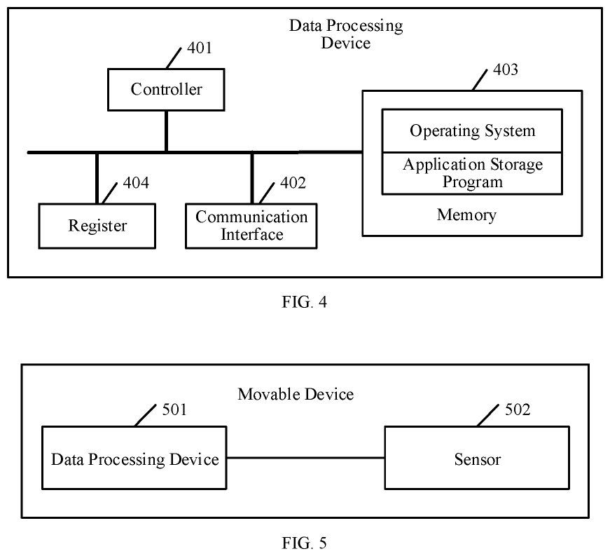

FIG. 4 is a schematic structural diagram of another data processing device according to an embodiment of the present disclosure. As shown in FIG. 4, the data processing device includes a controller 401, a communication interface 402, a memory 403, and a register 404. The controller 401, the communication interface 402, the memory 403, and the register 404 may be connected through a bus or other means. In some embodiments, a bus connection is taken as an example.

The controller 401 may be a central processing unit (CPU), a network processor (NP), or a combination of CPU and NP. The controller 401 may also be a core used to implement communication identification binding of a multi-core CPU or a multi-core NP.

The controller 401 may be a chip. The chip may be an application-specific integrated circuit (ASIC), a programmable logic device (PLD), or a combination thereof. The PLD can be a complex programmable logic device (CPLD), a field-programmable gate array (FPGA), a general array logic (GAL), or any combination thereof.

The communication interface 402 may be configured for the interaction of receiving and sending information or signaling, and the reception and transmission of signals. The register 404 is configured to store sensor data and the register 404 is connected to the sensor. The memory 403 may mainly include a program storage area and a data storage area. The program storage area may store an operating system and storing programs for at least one function (such as text storing function, location storing function, etc.), and the data storage area can store data created according to the use of the device (such as image data, text data), and can include application storage programs, etc. In addition, the memory 403 may include a high-speed random-access memory, and may also include a non-volatile memory, such as at least one of a magnetic disk storage device, a flash memory device, or other volatile solid-state storage device.

The memory 403 is also configured to store program instructions. The controller 401 is configured to execute the program instructions stored in the memory 403, and when the program instructions are executed, the controller 401 is configured to obtain a target amount value, which is used to indicate the amount of sensor data that needs to be transmitted, and read and transmit sensor data from a sensor according to the target amount value.

The target amount value is calculated according to a first amount value and a second amount value, the first amount value is the amount of sensor data that the sensor has currently obtained, and the second amount value is calculated according to the first amount value and a preset calculation rule.

In some embodiments, the controller 401 is configured to read and transmit sensor data from the register 404 according to the target amount value.

In some embodiments, calculating the second amount value according to the first amount value and the preset calculation rule refers to that with the second amount value, the time for the sensor to obtain sensor data of the amount corresponding to the second amount value is not greater than a target time value.

The target time value includes at least the sum of the time to read sensor data of the amount corresponding to the first amount value, and the time to read sensor data of the amount corresponding to the second amount value.

In some embodiments, the target time value further includes a response time when reading sensor data, and the response time includes at least a calculation time for calculating the second amount value according to the first amount value and the preset calculation rule.

In some embodiments, the time to read sensor data of the amount corresponding to the first amount value includes the product of the first amount value and the time to read a single unit of data, and plus the time to read a single unit of data.

In some embodiments, the time to read sensor data of the amount corresponding to the second amount value includes the product of the second amount value and the time to read a single unit of data minus the time to read a single unit of data.

In some embodiments, the controller 401 is configured to read the first amount value, calculate the second amount value according to the first amount value and the preset calculation rule, and calculate the target amount value according to the first amount value and the second amount value.

In some embodiments, the target amount value is a sum of the first amount value and the second amount value.

In some embodiments, the sensor is connected to the controller 401 via a bus, and the controller 401 is further configured to obtain a bus type of the bus and determine the reading duration for reading single unit of data according to the bus type.

In some embodiments, the controller 401 is further configured to obtain the type of the sensor and determine a sampling rate of the sensor according to the type of the sensor.

A reading rate of sensor data is set according to the sampling rate and the capacity of the register 404, so as to ensure that the sensor data stored in the register 404 does not exceed the capacity of the register 404.

In some embodiments, the first amount value being the amount of sensor data that the sensor has currently obtained refers to that according to a preset interrupt mechanism, when the sensor acquires sensor data with a preset amount, the controller 401 is triggered to start reading sensor data according to the target amount value. The preset amount is the amount corresponding to the first amount value.

In some embodiments, the controller 401 is configured to obtain the type of the sensor, determine a sampling rate of the sensor according to the type of the sensor, and calculate the second amount value according to the first amount value, the sampling rate, and the preset calculation rule.

In some embodiments, the sensor data is the sensing data of a gyroscope.

In some specific implementations, the controller 401, the communication interface 402, the memory 403, and the register 404 consistent with embodiments of the present disclosure can perform the implementation described in the data processing method provided by the embodiments of the present disclosure, and details are not described herein.

In some embodiments, the controller 401 first obtains the target amount value, which is used to indicate the amount of sensor data that needs to be transmitted, and then reads and transmits the sensor data from the sensor according to the target amount value. The target amount value is calculated based on the first amount value and the second amount value, the first amount value is the amount of sensor data that the sensor has currently obtained, and the second amount value is calculated according to the first amount value and the preset calculation rules. By adopting the above method, the sensor data can be read in advance, which can reduce the delay of reading the sensor data, and ensure that after each data reading is completed, the sampled sensor data basically has no residue. As a result, the real-time performance of reading sensor data is effectively improved.

FIG. 5 is a schematic structural diagram of a movable device according to an embodiment of the present disclosure. The movable device includes a movable device body, a data processing device 501 provided at the movable device body as described above, and a sensor 502. The sensor 502 is configured to obtain sensing information of the movable device and/or the environment in which the movable device is located.

The data processing device 501 is configured to obtain a target amount value, which is used to indicate the amount of sensor data that needs to be transmitted, and read and transmit sensor data from a sensor according to the target amount value.

The target amount value is calculated according to a first amount value and a second amount value, the first amount value is the amount of sensor data that the sensor has currently obtained, and the second amount value is calculated according to the first amount value and a preset calculation rule.

In some embodiments, calculating the second amount value according to the first amount value and the preset calculation rule refers to that with the second amount value, the time for the sensor to obtain sensor data of the amount corresponding to the second amount value is not greater than a target time value.

The target time value includes at least the sum of the time to read sensor data of the amount corresponding to the first amount value, and the time to read sensor data of the amount corresponding to the second amount value.

In some embodiments, the target time value further includes a response time when reading sensor data, and the response time includes at least a calculation time for calculating the second amount value according to the first amount value and the preset calculation rule.

In some embodiments, the time to read sensor data of the amount corresponding to the first amount value includes the product of the first amount value and the time to read a single unit of data, and plus the time to read a single unit of data.

In some embodiments, the time to read the amount of sensor data corresponding to the second amount value includes the product of the second amount value and the time to read a single unit of data minus the time to read a single unit of data.

In some embodiments, the target amount value is a sum of the first amount value and the second amount value.

In some embodiments, the sensor 502 is connected to the data processing device 501 via a bus or other ways, and the data processing device 501 is further configured to obtain a bus type of the bus and determine the reading duration for reading single unit of data according to the bus type.

In some embodiments, the data processing device 501 is further configured to obtain the type of the sensor, determine a sampling rate of the sensor according to the type of the sensor, and set a reading rate of sensor data according to the sampling rate and the capacity of the register, so as to ensure that the sensor data stored in the register does not exceed the capacity of the register.

In some embodiments, the first amount value being the amount of sensor data that the sensor has currently obtained refers to that according to a preset interrupt mechanism, when the sensor acquires sensor data with a preset amount, the controller 401 is triggered to start reading sensor data according to the target amount value. The preset amount is the amount corresponding to the first amount value.

In some embodiments, the data processing device 501 is configured to obtain the type of the sensor, determine a sampling rate of the sensor according to the type of the sensor, and calculate the second amount value according to the first amount value, the sampling rate, and the preset calculation rule.

In some embodiments, the sensor 502 is a gyroscope sensor.

In some embodiments, the movable device is a gimbal or a UAV carrying a gimbal.

In some specific implementations, the movable device described consistent with embodiments of the present disclosure can perform the implementation described in the data processing method provided by the embodiments of the present disclosure. For the structure and function of the data processing device 501, reference may be made to the foregoing description, which will not be repeated here.

In some embodiments, the data processing device 501 first obtains the target amount value, which is used to indicate the amount of sensor data that needs to be transmitted, and then reads and transmits the sensor data from the sensor according to the target amount value. The target amount value is calculated based on the first amount value and the second amount value, the first amount value is the amount of sensor data that the sensor has currently obtained, and the second amount value is calculated according to the first amount value and the preset calculation rules. By adopting the above method, the sensor data can be read in advance, which can reduce the delay of reading the sensor data, and ensure that after each data reading is completed, the sampled sensor data basically has no residue. As a result, the real-time performance of reading sensor data is effectively improved.

A controller is further provided according to an embodiment of the present disclosure and the controller can execute the implementation described in the data processing method provided by the embodiment of the present disclosure, and details are not repeated herein.

A computer-readable storage medium is also provided according to the embodiments of the present disclosure. A computer program is stored in the computer-readable storage medium. When the computer program is executed by a processor, each step described in the corresponding method of the embodiments may be implemented.

For the convenience of description, in the foregoing embodiments, the methods are all expressed as a series of action combinations, but those skilled in the art should be aware that the present disclosure is not limited by the sequence of actions described. Because according to this disclosure, certain processes can be performed in other orders or simultaneously. Secondly, those skilled in the art should be also aware that the embodiments described in the disclosure are all preferred embodiments, and the involved actions and modules are not necessarily required by this disclosure.

A person of ordinary skill in the art may understand that all or part of the processes in the various methods of the above embodiments may be completed by a program instructing related hardware. The program may be stored in a computer-readable storage medium, and the storage medium may include a flash disk, a read-only memory (ROM), a random-access memory (RAM), a magnetic disk or an optical disk, etc.

A data processing method and device, a controller, and a movable device provided consistent with embodiments of the present disclosure are described in detail above. Specific examples are used in this disclosure to explain the principles and implementation methods of the present disclosure. The explanation is only used to help understand the method and the principle of this disclosure. For those of ordinary skill in the art, according to the principle of this disclosure, there will be changes in the specific implementation and application. In summary, the content of this disclosure should not be construed as limiting the disclosure.

What is claimed is:

1. A data processing method comprising:
determining a target amount according to:
a first amount indicating an amount of obtained data that a sensor has currently obtained, and
a second amount calculated according to the first amount and a preset calculation rule;
reading sensor data from the sensor according to the target amount; and
transmitting the read sensor data.

2. The method of claim 1, wherein the preset calculation rule includes that a time for the sensor to obtain the second amount of sensor data is not greater than a target time, the target time including at least a sum of a time to read the first amount of sensor data and a time to read the second amount of sensor data.

3. The method of claim 2, wherein the target time further includes a response time for reading the sensor data, the response time including at least a calculation time for calculating the second amount according to the first amount and the preset calculation rule.

4. The method of claim 2, wherein:
the time to read the first amount of sensor data includes a product of the first amount and a unit-reading time, plus the unit-reading time, the unit-reading time being a time to read a single unit of data; or
the time to read the second amount of sensor data includes a product of the second amount and the unit-reading time, minus the unit-reading time.

5. The method of claim 1, further comprising, before obtaining the target amount:
obtaining a type of the sensor; and
determining a sampling rate of the sensor according to the type of the sensor; and
setting a reading rate for reading the sensor data according to the sampling rate and a capacity of a register, to ensure that an amount of sensor data stored in the register does not exceed the capacity of the register.

6. A movable device comprising:
a movable device body; and
a data processing device provided at the movable device body and including a controller configured to:
determine a target amount according to:
a first amount indicating an amount of obtained data that a sensor has currently obtained, and
a second amount calculated according to the first amount and a preset calculation rule;
read sensor data from the sensor according to the target amount; and
transmit the read sensor data.

7. The movable device of claim 6, further comprising:
the sensor, the sensor being configured to obtain sensing information of at least one of the movable device or an environment in which the movable device is located.

8. The movable device of claim 7, wherein the sensor includes a gyroscope sensor.

9. The movable device of claim 6, wherein the movable device includes at least one of a gimbal or an unmanned aerial vehicle (UAV) carrying a gimbal.

10. The movable device of claim 6, wherein the preset calculation rule includes that a time for the sensor to obtain the second amount of sensor data is not greater than a target time, the target time including at least a sum of a time to read the first amount of sensor data and a time to read the second amount of sensor data.

11. The movable device of claim 10, wherein the target time further includes a response time for reading the sensor data, the response time including at least a calculation time for calculating the second amount according to the first amount and the preset calculation rule.

12. The movable device of claim 10, wherein the time to read the first amount of sensor data includes a product of the first amount and a unit-reading time, plus the unit-reading time, the unit-reading time being a time to read a single unit of data.

13. The movable device of claim 10, wherein the time to read the second amount of sensor data includes a product of the second amount and a unit-reading time, minus the unit-reading time, the unit-reading time being a time to read a single unit of data.

14. The movable device of claim 6, wherein the controller is further configured to:
read the first amount;
calculate the second amount according to the first amount and the preset calculation rule; and
calculate the target amount according to the first amount and the second amount.

15. The movable device of claim 14, wherein the target amount is a sum of the first amount and the second amount.

16. The movable device of claim 6, wherein the sensor is connected to the controller via a bus, and the controller is further configured to:
obtain a bus type of the bus; and
determine a reading duration for reading a single unit of data according to the bus type.

17. The movable device of claim 6, further comprising:
a register;
wherein the controller is further configured to:
obtain a type of the sensor; and
determine a sampling rate of the sensor according to the type of the sensor; and
set a reading rate for reading the sensor data according to the sampling rate and a capacity of the register, to ensure that an amount of sensor data stored in the register does not exceed the capacity of the register.

18. The movable device of claim 6, wherein the controller is further configured to, according to a preset interrupt mechanism, start to read the sensor data according to the target amount in response to the sensor having acquired the first amount of sensor data.

19. The movable device of claim 18, wherein the controller is further configured to:
obtain a type of the sensor; and
determine a sampling rate of the sensor according to the type of the sensor; and
calculate the second amount according to the first amount, the sampling rate, and the preset calculation rule.

20. The movable device of claim 6, wherein the sensor data includes sensing data of a gyroscope.
